(19) United States
(12) Patent Application Publication
(10) Pub. No.: US 2026/0197313 A1
(43) Pub. Date: Jul. 9, 2026

(54) SYSTEM AND METHOD FOR BUILDING APPLICATION-SPECIFIC INTERNETWORKING NODES WITH REDUCED SECURITY VULNERABILITIES

(71) Applicant: KAROUSELS INC., Mendota Heights, MN (US)

(72) Inventors: Som SIKDAR, San Jose, CA (US); Jeffrey Michael COLLINS, Brighton, CO (US)

(21) Appl. No.: 19/133,533

(22) PCT Filed: Nov. 30, 2023
(86) PCT No.: PCT/IB2023/062087

§ 371 Date: May 28, 2025

Related U.S. Application Data
(60) Provisional application No. 63/385,566, filed on Nov. 30, 2022.

(51) Int. Cl. H04L 9/40

(52) U.S. Cl. CPC H04L 63/10

(57) ABSTRACT

A method of building a plurality of application specific internetworking routers for a network. For each of the plurality of application specific internetworking routers a common base image is pulled. A common set of the plurality of functionalities is added to the base image as one or more common layers. A varied set of the plurality of functionalities is added on top of the one or more common layers as one or more optional layers. An application specific internetworking router image is created from the base image, the one or more common layers, and the one or more optional layers. The plurality of application specific internetworking router images is run via a respective Docker run command or a respective Docker compose file script.

### BACKGROUND

Internetworking nodes (e.g., routers and switches) are vulnerable to attack by hackers, threat actors, and other attackers. The “attack surface” of a node refers to the externally exposed aspects of the node that can be accessed and potentially exploited by an attacker. The attack surface includes boundary elements that are present in the node when it is placed into service, software modules that are bundled in the deployment but not in use, as well as new vulnerabilities that are added during service. These new vulnerabilities are often caused by operational misconfigurations of a node, which can cause network outages directly or can expose openings which attackers can exploit. These vulnerabilities can impact network services and business operations. A larger attack surface means there are more aspects that a hacker can access and, therefore, there are more potential avenues that a hacker can use to commandeer the router. A smaller attack surface, in contrast, provides fewer options that a hacker can exploit.

### SUMMARY OF THE INVENTION

Embodiments described herein provide for a method of building a plurality of application specific internetworking routers for a network. The method comprises pulling a first copy of a base image for a first application specific router. The method also comprises adding at least a first common layer on top of the first copy of the base image, the at least a first common layer for implementing a first functionality on the first application specific router. The method further comprises adding at least a first optional layer on top of the at least a first common layer, the at least a first optional layer for implementing a second functionality on the first application specific router. A first image is created incorporating the first copy of the base image, the at least a first common layer, and the at least a first optional layer. The method also includes pulling a second copy of the base image for a second application specific router. At least a second common layer is added on top of the second copy of the base image. The at least a second common layer for implementing the first functionality on the second application specific router. At least a second optional layer is added on top of the at least a second common layer. The at least a second optional layer for implementing a third functionality on the second application specific router. A second image is created incorporating the first copy of the base layer, the at least a second common layer, and the second one or more optional layers. The first image and the second image are run via a Docker run command or a Docker compose file script.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an example application specific immutable network router (ASINR);

FIG. 2 is a block diagram of an example system including a private service access network including a plurality of ASINRs of FIG. 1;

FIG. 3 is a block diagram of an example software system for creating a plurality of ASINRs;

FIG. 4 is a flow diagram illustrating a process that can be implemented by the system of FIG. 3 to create a plurality of ASINRs;

FIG. 5 is a block diagram of an example network including a plurality of ASINRs that can be built according to the process of FIG. 4; and

FIG. 6 is a block diagram of an example device which can host an execution environment for an ASINR of FIG. 1.

### DETAILED DESCRIPTION

Typical general purpose internetworking nodes are highly configurable. To enable such high configurability, the nodes support a wide variety of optional features and provide an interface (e.g., application programming interface) through which an administrator can adjust settings for each of the optional features. Many features can be enabled or disabled (e.g., enabling or disabling IPsec support for a network interface). Other features have a selectable setting that can be set to one of multiple different states. Example selectable settings include a speed for a network interface, for example, selected from a set including 10 Mbps, 100 Mbps, 500 Mbps, 1 Gbps, 10 Gbps, and 100 Gbps or configuration of “link aggregation” for multiple interfaces. Modern networking devices can have a plethora of such settings and include software code modules for every feature/setting that is supported. This software code remains dormant unless that feature/setting is enabled. There can be hundreds of modules of dormant code in a modern networking device. Both the configurability and existence of dormant code increase the attack surface of the device.

Existing internetworking nodes are also manually or programmatically re-configurable so that they can be set-up as desired and adapted as needed to address changes in the network. Internetworking nodes must fit the requirements of their particular location (i.e., the site where the device is deployed) at that point in time, but those requirements may change over time and/or the node may change locations in the network. Thus, internetworking nodes are typically configurable “in the field”. In order to access the device in the field—operator credentials are installed and access ports are made visible to the external world. The exposed accessibility provided for such configuration provides an additional attack surface for attackers to exploit.

A third contributor to the attack surface of existing internetworking nodes is the limited ability to test if a node is operating in the best configuration from a holistic system wide basis. Testing can be performed on a single internetworking node to understand its vulnerabilities individually, but existing networks often include many internetworking nodes that work together to provide the network functionality. It is difficult to test each internetworking node to determine if it is operating in the best configuration from the network wide perspective. Existence of deployed but unused software modules and programmability of options increase the possible test-requirements manyfold and make it impossible to test all the corner cases of operation.

Embodiments described herein provide for systems and methods for an internetworking node with a reduced attack surface. The systems and methods described herein address the above security vulnerabilities by providing for an internetworking node that is application specific and immutable. Application specific refers to nodes having functions and attributes that are specific to a particular location of the network without other functions and attributes that are not needed for its particular deployment. That is, the application specific node has a customized set of features and attributes that are different from other nodes and does not include dormant unused code for features/settings that are not enabled. Immutable refers to the network nodes providing no means to make configuration changes. If a new feature is needed that requires software or configuration change—then a completely new network node is created in software and deployed. Thus, security vulnerabilities can be eliminated while still providing customized network nodes.

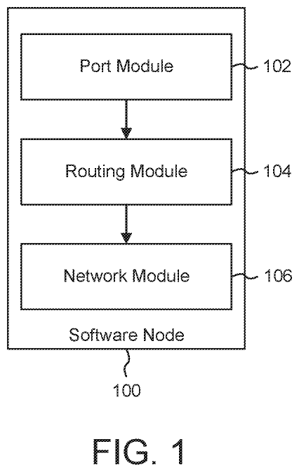

FIG. 1 is a block diagram of an example application specific immutable network router (ASINR) 100. The ASINR 100 is an internetworking device implemented in software. When executed, the software of the ASINR 100 implements the networking functions of the ASINR 100. For example, the ASINR 100 can provide networking services such as OSI layer 3 and OSI layer 4 services such as routing of packets, IP discovery, and tunneling of packets among other things. The software of the ASINR 100 is configured to execute within an execution environment, such as a virtual machine, a virtual operating system (OS), a bare metal server, or other infrastructure. In an example, the ASINR 100 is configured to execute within a Docker Engine.

The software of the ASINR 100 hard codes the features/functions implemented by the ASINR 100. That is, the functions and features of the ASINR 100 are immutable. In contrast to existing internetworking devices, the software implementing the ASINR 100 provides no settings that can be adjusted by an administrator. That is, the ASINR 100 does not include an interface for an external operator to change a configuration of the code for any of its features/functions, including the plurality of network ports, the one or more routing protocols, any IP addresses of the computer program, and any network layer protocols. Instead, the software includes hard coded modules 102-106 that are always executing and continually implement the features/functions of the module. As such, the features/functions implemented by the software for the ASINR 100 are fixed and unchangeable. By being immutable, the ASINR 100 has fewer security vulnerabilities, because there are no configuration settings that an attacker can exploit.

Additionally, the ASINR 100 hard codes only the features/functions that it will use to operate in the particular location at the particular time. That is, the ASINR 100 is customized to include the features/functions needed for its particular location and time, and no additional features. By eliminating features/functions that are not needed at the particular time and location, there is less code and features/functions available for an attacker to exploit. Because existing general-purpose configurable internetworking devices can have hundreds of code modules, the vast majority of which are not used in a given implementation, the overall amount of code included in the ASINR 100 described herein can be drastically lower than existing devices.

Furthermore, the systems and methods described herein provide a means for holistic testing of the ASINR 100 as it will be implemented in the network. This enables more security vulnerabilities to be identified and addressed prior to implementation of the ASINR 100.

Any appropriate function can be implemented by the ASINR 100 by including a corresponding module 102-106 for that function in the software of the node 100. The example modules 102-106 shown in FIG. 1 include a port module 102 that hard codes a plurality of network ports. The port module 102 can hard code a physical layer protocol and a data link layer protocol for each of the ports. An example physical layer protocol and a data link layer protocol includes an IEEE 802 protocol, such as IEEE 802.3u (100 Mbps Fast Ethernet), IEEE 802.3ac (1 Gbps), IEEE 802.3ae (10 Gbps), and IEEE 802.3bm (100 Gbps). The ASINR 100 can also include a routing module 104 that hard codes one or more routing protocols for transferring packets between the plurality of network ports. Example routing protocols that can be implemented include a Border Gateway Protocol (BGP) protocol and an Optimal Shortest Path First (OSPF) protocol. The ASINR 100 can also include a network module 106 that hard codes one or more network layer protocols for each of the plurality of ports. Example network layer protocols that can be implemented include IPsec and SSL. As mentioned above, each hard coded function (e.g., number of ports, physical layer protocol, data link layer protocol, network layer protocol, and routing protocol) that is hard coded in the software (e.g., in a module 102-104) of the node 100 is unchangeable. That is, each hard coded function is always implemented and cannot be disabled. Moreover, the software for the ASINR 100 does not include any additional functions that can be selectively enabled by an administrator. All functions are continually executed, and no additional functions are included.

Other hard coded functions can be included in the software node, such as the IP address associated with each port, network address translation protocol, and access controls. Access controls can include rules indicating which packets are allowed to be transferred to which ports. Any suitable rules can be implemented including rules based on which clients are allowed access to which network resources in a network and the conditions under which that access is allowed. The rules can include user-based restrictions, device-based restrictions, location-based restrictions, time-based restrictions and others. User-based restrictions can include which users operating a client are allowed access to which network services. Device-based restrictions can refer to a particular client or physical device (e.g., a MAC address). Location-based restrictions can include the network location of the client (e.g., the LAN or subnet that the client 204 is a part of) or a physical location of a device on which the client executes (e.g., GPS coordinates). Time-base restrictions can include a time of day, a day of week, or length of time from grant of access (e.g., 1 week). A combination of multiple conditions can also be required such as a device-based restriction and a time-based restriction. In any case, the access permissions indicate the conditions under which a client is to be granted access to a particular network service. In an example, the ASINR 100 implements the access controls by only transferring packets between ports if the access controls indicate that the client associated with a packet is allowed to access the network service to which the packet is destined. If a packet from a client meets the conditions defined in the access controls, the packet is forwarded to the appropriate port. If the packet does not meet the conditions defined in the access controls, the packet is not forwarded by the ASINR 100 and, therefore, access to the network service is denied.

As mentioned above, the software implementing the ASINR 100 includes code that is configured to execute within an execution environment and perform certain functions as described above. In an example, the software is a Docker container image that is configured to execute within a Docker Engine. As known, a Docker container image is an immutable file that is executed with a Docker Engine to perform its desired functions. In other examples, the software implementing the ASINR 100 can take other forms including code that executes as a virtual machine or code that executes in a hypervisor. In yet other examples, the software is an application and the execution environments are an operating system. The execution environment for the software can be disposed on a public server (e.g., AWS or Google server), and/or one or more serverless functions (e.g., a Lambda function, Compute function, Azure function, etc.).

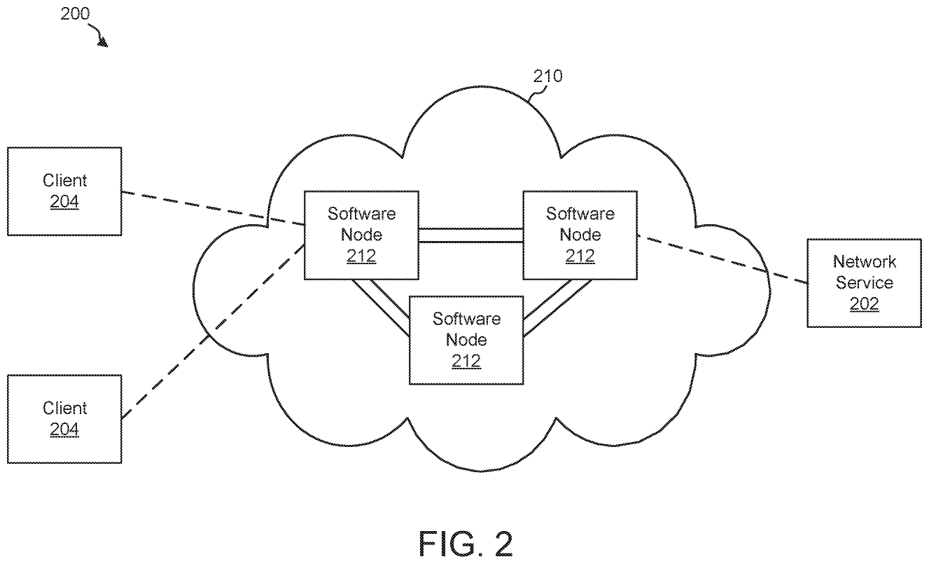

FIG. 2 is a block diagram of an example system 200 including a private service access network (PSAN) 210 including a plurality of ASINRs 100. The PSAN 210 provides selective access to one or more network services 202 for a plurality of clients 204. Each network service 202 is software executing in an execution environment 206, such as a virtual machine, virtual operating system (OS), bare metal server, or other infrastructure. Example network services 202 include Microsoft Exchange, file servers, sharepoint, billing services, printers, and others. Each client 204 is software executing in an execution environment 208, such as a personal computing device (PC) (e.g., desktop, laptop, tablet, mobile phone), virtual machine, virtual OS, or other infrastructure. Example clients 204 include user applications such as Microsoft Outlook and Microsoft Word, and embedded software, such as firmware executing on a component of a process control system. Execution environment(s) 208 for the client(s) 204 can be the same or different from execution environment(s) 206 of the service(s) 204.

The plurality of ASINRs 100 cooperate to provide selective access to the network service(s) 204 for the clients 204. At least a subset of the ASINRs 100 are configured to implement one or more IP networks, wherein each ASINRs 100 of the subset operates as an IP networking device. Example networking devices implemented by a node 100 include a router/gateway that performs protocol translation, a switch that does not perform protocol translation, and encryption/decryption device. The network service(s) 202 and the clients 204 can use known network protocols (like DNS) to discover one another via the PSAN 210.

The PSAN 210 can provide selective network paths between the clients 204 and the network service(s) 202. The PSAN 210 limits access to the network service(s) 202 based on access permissions for the PSAN 210. ASINRs 100 implements the access permissions such that access to the network service(s) 202 is restricted, except as allowed by the configuration rules. In this way, access to the network service(s) 202 can be controlled by the ASINRs 100 of the PSAN 210. System 200 described in PCT Application No. PCT/US2023/034230 is an example system in which a plurality of ASINRs 100 can be implemented. PCT Application No. PCT/US2023/034230, entitled “SYSTEM AND METHOD FOR CREATING A PRIVATE SERVICE ACCESS NETWORK”, filed on Sep. 29, 2023, is hereby incorporated herein by reference.

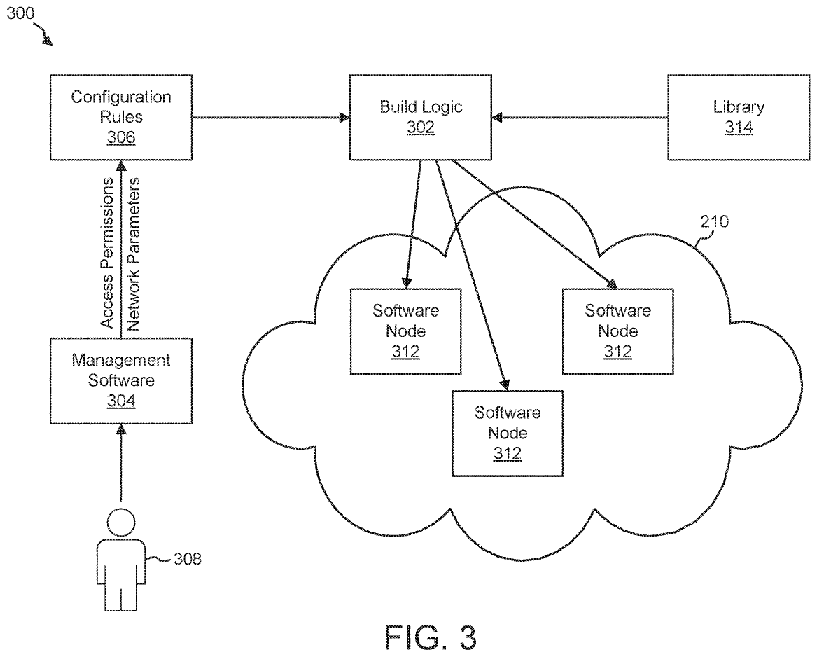

FIG. 3 is a block diagram of an example software system 300 for creating a plurality of ASINRs 100. Although an ASINR 100 hard codes its features/functions, system 300 provides means for an administrator to select and implement the desired features/functions in each ASINR 100. This is accomplished by custom building each ASINR 100 based on information provided from an administrator. Thus, each ASINR 100 can include the precise features/functions desired by the administrator and no additional features.

System 300 includes build logic 302 that creates the ASINRs 100. The build logic 302 creates the software that makes up the ASINRs 100 based on configuration rules 306. The configuration rules 306 are a collection of information that includes the parameters for the PSAN. The configuration rules 306 are accessible to the build logic 302, and the build logic 302 creates the ASINRs 100 in accordance with the configuration rules 306. The network parameters in the configuration rules 306 incorporate the access permissions for the PSAN, such that the creation of the ASINRs 100 in accordance with the configuration rules 306 implements the access permissions in the PSAN.

The system 300 includes management software 304 which is configured to receive information from an administrator 308 for the system 300 and maintain the configuration rules 306 based thereon. The management software 304 can provide a management portal that receives the information from the administrator 308 and displays information regarding the system 300 to the administrator 308. The management software 304 maintains the configuration rules 306 by updating the rules 306 such that they reflect information received from an administrator 308. The management software 304 can include any suitable mechanism for authenticating the administrator 308 and maintaining the configuration rules 306.

The configuration rules 306 can be stored in any suitable format and in any suitable location. For example, the configuration rules 306 can be stored in a database or immutable ledger. To maintain the configuration rules 306, the management software 304 updates the database or adds to the immutable ledger such that the current configuration rules in the database or immutable ledger reflects any updated information received from the administrator 308.

To build the PSAN 210, the build logic 302 creates and activates the plurality of ASINRs 100. Each ASINR 100 can include a software data plane having a plurality of ports for sending and receiving packets. The software data plane of an ASINR 100 can receive, process, and forward packets between the plurality of ports in order to implement the desired function for the ASINR 100. For ASINRs 100 that implement layer 3 and/or layer 4 networking functions, processing the packets includes determining which port to forward the packets too. The ASINRs 100 can implement part or all of the access restrictions by only forwarding packets that are allowed by the access permissions. That is, if there is no allowance for a packet that is defined in the configuration rules and built into a ASINR 100, the packet will not be forwarded by an ASINR 100 and access to network service(s) for that packet will be denied. By referencing the configuration rules 306, the build logic 302 creates each ASINR 100 as a unique entity that implements the functions defined for it in the configuration rules 306.

The PSAN 210 can utilize multiple execution environments to execute the plurality of ASINR 100. The execution environments can be established at one or more physical locations as needed to implement the functions of the PSAN 210. For example, the execution environments can be established on one or more private servers, one or more public servers, and/or one or more serverless functions. In any case, information pertaining to each execution environment available for the PSAN 210 is included in the configuration rules 306. Execution environment information can include information used to communicate with the execution environment. This execution environment information can include, for each execution environment, a unique ID, a network address for the environment, credentials for the environment, network port(s) for the environment, and a type of environment. The unique ID can be any suitable uniquely identifiable code, such as an alpha-numeric code or name. The network address and port(s) are the network locations with which the build logic 302 can communicate with the execution environment. In an example, the network address is an IP address and the network port(s) are TCPIP ports or SSH ports. The credentials can include the encryption protocol and/or key used for communication between the build logic 302 and the execution environment. In an example, the type of execution environment can include one of an operating system on a device, a virtual machine, a virtual OS, or a bare metal server. Each execution environment can include respective parameters such that the build logic 302 can use the parameters to send code packages to each execution environment and to instruct the execution environments regarding activation of each code package (e.g., instructions to activate or disable a particular code package).

To create an ASINR 100, the build logic 302 pulls code functions from a library 308 and adds in appropriate parameters to the code functions such that the ASINR 100 implements the functions defined in the configuration rules 306. For example, if a first ASINR 100 is to implement an IPsec tunnel path to a second software node, the build logic 302 pulls the code function for an IPsec tunnel and inserts it into the code package for the first ASINR 100. The build logic 302 augments the code function such that it forms the IPsec tunnel with the IP address of the second ASINR 100. The build logic 302 similarly creates the second ASINR 100. In this way, the build logic 302 creates first and second ASINRs 100 that implement an IPsec tunnel therebetween. Once all the desired code functions are included in a code package, the code package can be compiled for execution within a specific execution environment.

As mentioned above, the functions performed by an ASINR 100 are defined as node parameters in the configuration rules 306 and the build logic 302 creates the ASINRs 100 in accordance with the node parameters and the configuration rules 306 more broadly. The node parameters can include, for each ASINR 100, a unique identifier (e.g., a unique name and/or alpha-numeric code), a type of node (e.g., router, encryption node, etc.), and other parameters. An encryption/decryption node encrypts and/or decrypts packets and forwards the packets.

The configuration rules can also include network link parameters. The network link parameters can include routing information such as where an ASINR 100 sends a particular packet, when to establish a link (e.g., route) to another ASINR 100, and what protocol to use for packets sent over that link. Example protocols that can be used include tunneling protocols such as IPsec and SSL. The network links implemented by the configuration rules 306 are logical (e.g., overlay) network links. That is, the network services, clients, and ASINRs 100 are configured to send packets between one another over the logical network links. Each logical network link can include zero, one, or multiple physical network links. For example, if an ASINR 100 is executing on the same physical device as a client, the client and the ASINR 100 can exchange packets by sending the packets between the software programs entirely on the device without traversing any physical network links. In contrast, if an ASINR 100 is executing on an Internet connected server and the client is connecting to the Internet from a remote location, there may be numerous physical network links and in fact multiple distinct autonomous systems between the client and the ASINR 100. Packets sent therebetween can be routed through the Internet in the normal manner based on the IP addresses of the client and the ASINR 100. The link between the network service(s) and the ASINRs 100 as well as between respective ASINRs 100 are also logical (e.g., overlay) network links.

The network parameters can also include client information. Client information can include a unique identifier (e.g., a unique name and/or alpha-numeric code) for each client of the network, a network address (e.g., IP address) for the client, one or more ports for the client, and one or more network services or network links that the client is allowed to access.

The combination of network link parameters and client parameters can be part of implementing the access permissions as discussed above. For example, if the link and client parameters indicate that an ASINR 100 is to forward a packet from User 1 having a destination IP address of Service 1 to a software node that provides access to Service 1, then the software nodes will provide access for User 1 to Service 1. If, however, no such forwarding parameter is defined in the network parameters, User 1 will not be allowed access to Service 1 via that ASINR 100.

After assembling the code package that will perform the functions of an ASINR 100 as defined in the configuration rules 306, the build logic 310 deploys and activates the ASINR 100. Deploying the ASINR 100 includes sending the code package for the ASINR 100 to its execution environment. In an example, the code and configuration package for each ASINR 100 can be sent to the address (e.g., IP address) of the execution environment (e.g., Docker Engine) assigned in the configuration rules 306 to execute that ASINR 100. The build logic 310 can then activate each code package to execute in the assigned execution environment. Upon execution by the execution environment, an ASINR 100 implements that path or other function that the build logic 310 included in its code package. In this way, the system 300 can create and implement the private service network 210.

While an ASINR 100 is immutable, the system 300 enables an administrator to modify the functions implemented by an ASINR 100 by replacing the ASINR 100 having first attributes with a new ASINR 100 having new attributes. Thus, each instance of an ASINR 100 still maintains the security benefits of being immutable, but the functions implemented can be changed by having the system 300 create and deploy a new (replacement) ASINR 100. The system 300 can disable the previous ASINR 100 upon activation of the new ASINR 100. A new node can be created by the system 300 in response to inputs from an administrator into the management software 304 corresponding to new functions for a given ASINR 100. Other ASINRs 100 in the PSAN 210 can remain as is or be replaced in the same manner. Systems 300 and 400 of PCT Application No. PCT/US2023/034230 are examples of systems for creating a plurality of ASINRs 100.

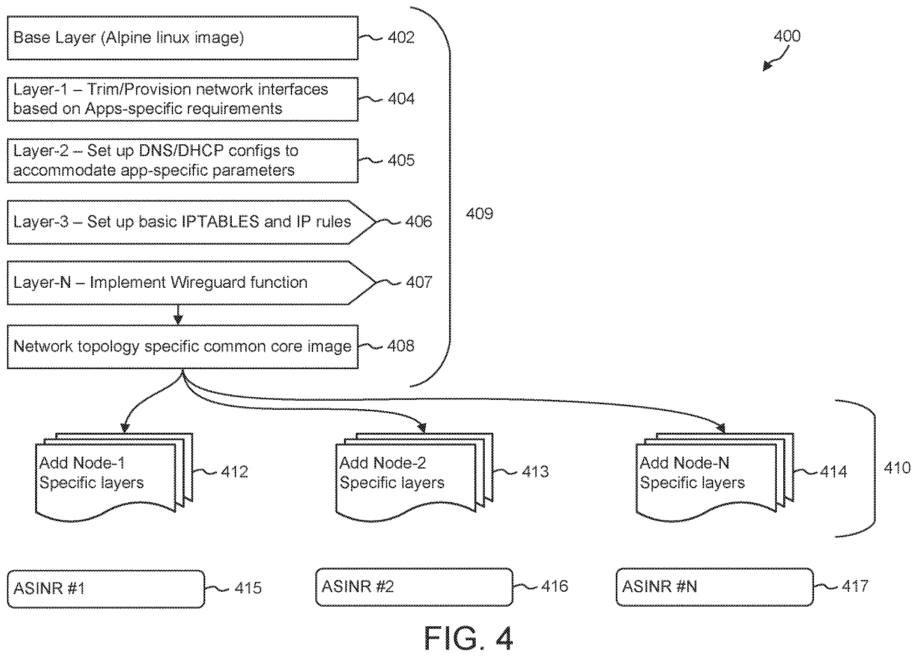

FIG. 4 is a flow diagram illustrating a process 400 that can be implemented by system 300 to create a plurality of ASINRs 100 via layering. An ASINR 100 is initially created by pulling an appropriate image (e.g., Docker image) to use as a base layer for the ASINR (block 402). The management software 304 can receive information indicating which base image to pull for the base layer from an administrator 308. Any appropriate image can be used, such as an image (Docker image) for running in a Docker engine and having a Linux distribution, such as an Alpine Linux image.

One or more additional layers are added on top of the base layer (blocks 404-407). Each additional layer can be added by pulling an appropriate image, implementing a CI/CD pipeline, or a Dockerfile. Each subsequent layer is added on top of (i.e., it interacts with) the layer below it. In the example shown in FIG. 4, the first layer disposed on the base layer adds the network interface functionality for the ASINR 100. The second layer is disposed of on the first layer and adds the DNS/DHCP configuration for the ASINR 100. The third layer is disposed on the second layer and adds the routing rules (IPTABLES and IP rules) for the ASINR 100. The fourth layer is disposed of on the third layer and adds the wireguard function for the ASINR 100. Any appropriate functionality can be added in these layers such as virtual tunnel functionality (for example wireguard, IPsec, MPLS, SOCKS, GRE, SSL, WebSocket, etc.), access control functionality, network service functionality (e.g., DNS, egress firewalls, DHCP, etc.), and other functionalities.

Building an ASINR 100 via layering can increase the ease of building and testing each ASINR 100. Each layer can utilize one or more pre-tested Docker images. For example, the first layer can define the number of ports for an ASINR 100 and the physical layer protocol and data link layer protocol for those ports. In such an example, each port implementing IEEE 802.3ac can utilize its own instance of a pre-tested Docker image that implements IEEE 802.3ac. The routing protocol can be, for example, a pre-tested OSPF Docker image that the Docker file codes to interact with the base layers. Networking layers (e.g., IPsec) can then interact with the routing layer and so on. Additional layers can be included in between and/or above and below any of these example layers. By using layers to build the ASINR 100, the system 300 can efficiently create new ASINRs 100 having the desired functionality.

The build process 400 can be organized such that one or more common layers 409 are added followed by one more optional layers 410. This organization can improve the ease of building multiple ASINRs 100 for a given network. Oftentimes, ASINRs 100 in a common network will each include common functionality that is required to implement the functionality of the network. Because this common functionality is required for all ASINRs 100 in a network (or a sub-network of the network), the build process for all ASINRs 100 for that network includes a layer for each of the required functions. A first image (Docker image) can be created incorporating the base layer and each of the common layers (block 408). Thus, the build process for each of the ASINRs 100 includes one or more common layers to include the common functionality on all the ASINRs 100. In the example shown in FIG. 4, there are five common layers including the base layer and layers 1-4 on top of the base layer. In other examples, other numbers and types of common layers can be included. Each common layer incorporates a given functionality into its ASINR 100, however, the parameters (e.g., DNS/DHCP settings, IP addresses, etc.) of the common layers can be adjusted to be unique for each ASINR 100 as appropriate. By adding the common layers before the optional layers, the layering for each ASINR 100 in the group is the same up through the end of the common layers 409. This can aid in reducing variance in the design of the ASINRs 100, which can provide for easier and more reliable testing of the ASINRs 100. Examples of a common layer include a specific sequence of Linux Debian version 10.3 with specific credentials that sets up site-specific syslog management, a DNS server with known hosts mappings for accessibility, and a metric logging module configuration.

After the common layers one or more optional layers 410 can be added to the first image (blocks 412-414). The optional layers are used to add functionality that is not necessarily present on all ASINRs 100 in the network. Any appropriate functionality can be included in an optional layer. That is, a given functionality, including any of the functionality discussed above (e.g., virtual tunnel functionality, access control functionality, network service functionality, etc.) can be implemented in either a common layer or an optional layer. Whether a given functionality is implemented as a common layer or an optional layer depends on whether that functionality is included in all ASINRs 100 in the network or sub-network. If the functionality (e.g., wireguard) is included in all ASINRs 100 in the network or sub-network, then the functionality can be implemented in a common layer 409. If the functionality is not included in all ASINRs 100 in the network or sub-network, then it is implemented as an optional layer.

Other example functionality that can be included in an optional layer 410 is a specific version of a program, such as an OpenSSH server package of a specific version, or a specific function for a portion of the ASINRs 100 in a network (e.g., all ASINRs 100 in China). Another example of an optional layer is an access control list that allows external networks to establish routing protocol (such as BGP) connections to a specific instance of ASINR. Still other example functionality that can be added in an optional layer 410 is third party functionality. For example, a third party can provide a system that monitors the network, for example wireshark network analyzer with eBPF filters, and third party functionality can be added to an ASINR 100 allowing the third party system to update the routing or other parameters of an ASINR 100 in response to an outage. This type of functionality can be implemented in an ASINR 100 or added to an existing network merely by building a replacement ASINR 100 and including a layer into the build process for the replacement ASINR 100 that implements the desired functionality (e.g., from a third party). Moreover, a client is not locked into that third party and can easily switch to another third party by building replacement ASINRs 100 and including a layer into the build process for those replacement ASINRs 100.

Once all layers have been added, a final image that implements the ASINR 100 is output (415-417). ASINR 100 can have a unique set of optional layers 410 and unique parameters in the common layers 409 which implement functionality that is specific to that ASINR 100. Thus, multiple ASINRs 100 can proceed through the common layers 409 in the same manner, and each ASINR 100 has its own optional layers 410 placed on top of the common layers 409. As a result, each ASINR 100 can have a distinct final image 415-417 corresponding to its distinct set of functionalities and parameters. A final image for an ASINR 100 can be run as a standalone image with the Docker run command or can be run as part of a Docker compose file, which executes a script to run multiple images.

Process 400 can be implemented in a single stage or multistage process. An example multi-stage process includes building as a first stage, releasing as a second stage, deploy-developing as a third stage, deploy-producing as a fourth stage, and deploying a client as a fifth stage. An example YAML file for such a multi-stage process is provided below. stages:

```
stages:
  - build
  - release
  - deploy-dev
  - deploy-prod
  - deploy-client
variables:
  AWS_ECS_CLUSTER: karousels
  AWS_ECS_SERVICE_NAME: ledger-service
  AWS_ECS_TASK_DEFINITION_NAME: ledger-service
cache:
  paths:
-  node_modules/
build:
  image: node:16
  stage: build
  script:
  - npm ci
  - npm run lint
  - npm run test
  - npm run compile
release:
  stage: release
  image:
  name: gcr.io/kaniko-project/executor:v1.6.0-debug
  entrypoint: [″″]
  script:
  - mkdir -p /kaniko/.docker
  - echo
″{\″auths\″:{\″$CI_REGISTRY\″:{\″username\″:\″$CI_REGISTRY_USER\″,\″password\″:\″$CI_REG
ISTRY_PASSWORD\″}}″ > /kaniko/.docker/config.json
  - PACKAGE_VERSION=$(grep 'version' package.json | cut -d ″'' -f4 | tr -d '[:space:]]')
  - /kaniko/executor -- context $CI_PROJECT_DIR -- dockerfile $CI_PROJECT_DIR/Dockerfile --
destination $CI_REGISTRY_IMAGE:$CI_COMMIT_TAG -- destination
$CI_REGISTRY_IMAGE:$PACKAGE_VERSION
  only:
  - main
  - dev
deploy-dev:
  image: python:2.7
  stage: deploy-dev
  before_script:
  - apt update -y
  - apt install awscli jq -y
  script:
  - export AWS_ECS_CLUSTER=karousels-dev
  - export AWS_ECS_SERVICE_NAME=ledger-service-dev
  - export AWS_ECS_TASK_DEFINITION_NAME=ledger-service-dev
  - export AWS_TASK_DEFINITION_FILE_NAME=ledger-service-task-definition-dev.json
  - bash .gitlab-deploy-ecs.sh
  only:
  - dev
deploy-prod:
  image: python:2.7
  stage: deploy-prod
  before_script:
  - apt update -y
  - apt install awscli jq -y
  script:
  - export AWS_TASK_DEFINITION_FILE_NAME=ledger-service-task-definition-prod.json
  - bash .gitlab-deploy-ecs.sh
  only:
  - main
deploy-cleverdome:
  image: python:2.7
  stage: deploy-client
  before_script:
  - apt update -y
  - apt install awscli jq -y
  script:
  - export AWS_ACCESS_KEY_ID=$AWS_ACCESS_KEY_ID_CD
  - export AWS_SECRET_ACCESS_KEY=$AWS_SECRET_ACCESS_KEY_CD
  - export
KAROUSELS_SQS_USER_ACCESS_KEY_ID=$KAROUSELS_SQS_USER_ACCESS_KEY_ID_CD
  - export
KAROUSELS_SQS_USER_SECRET_ACCESS_KEY=$KAROUSELS_SQS_USER_SECRET_ACCESS_KEY_
CD
  - export AWS_TASK_DEFINITION_FILE_NAME=ledger-service-task-definition-cleverdome.json
  - bash .gitlab-deploy-ecs.sh
  only:
  - main
deploy-21p:
  image: python:2.7
  stage: deploy-client
  before_script:
  - apt update -y
  - apt install awscli jq -y
  script:
  - export AWS_ACCESS_KEY_ID=$AWS_ACCESS_KEY_ID_21P
  - export AWS_SECRET_ACCESS_KEY=$AWS_SECRET_ACCESS_KEY_21P
  - export
KAROUSELS_SQS_USER_ACCESS_KEY_ID=$KAROUSELS_SQS_USER_ACCESS_KEY_ID_21P
  - export
KAROUSELS_SQS_USER_SECRET_ACCESS_KEY=$KAROUSELS_SQS_USER_SECRET_ACCESS_KEY_
21P
  - export AWS_TASK_DEFINITION_FILE_NAME=ledger-service-task-definition-21p.json
  - bash .gitlab-deploy-ecs.sh
  only:
  - main
```

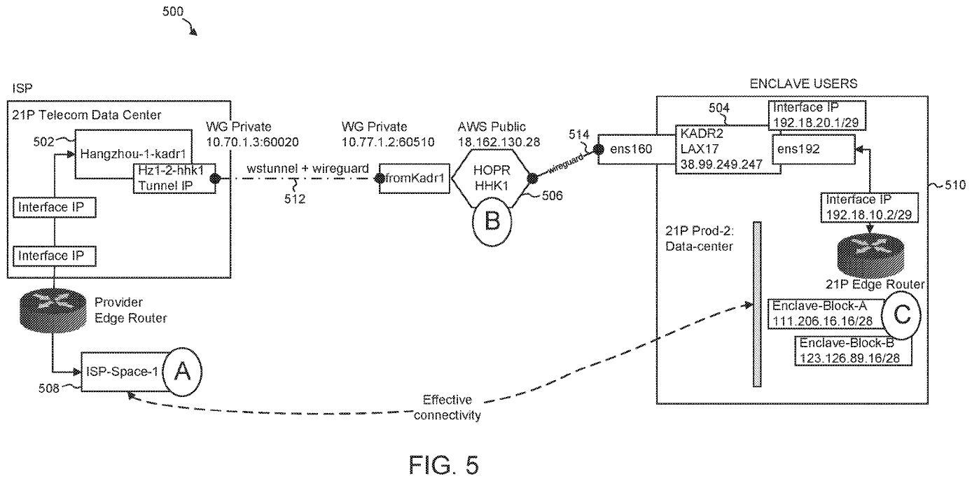

FIG. 5 is a block diagram of an example network 500 including a plurality of ASINRs 100 that can be built according to process 400. Network 500 includes three ASINRs 502, 504, 506 which operate to provide a network path between a first enclave 508 (e.g., located in China) and a second enclave 510 (e.g., located in the United States). Each enclave 508, 510 includes a defines set of IP addresses (e.g., a block of IP addresses from an ISP) and can correspondingly include a plurality of clients communicating over IP networks. In an example, each enclave 508, 510 includes one or more locate area networks (LANs). The network 500 operates to provide network connectivity to network services in the first enclave 508 for clients within the second enclave 510. A first ASINR 502 operates as a gateway for the first enclave 508 and a second ASINR 504 operates as a gateway for the second enclave 510. The first and second ASINRs 502, 504 create a logical network path therebetween to communicatively couple the first enclave 508 to the second enclave 510. A third ASINR 506 operates as an intermediate node, wherein the logical network path between the first ASINR 502 and the second ASINR 504 includes a first logical network link 512 between the first ASINR 502 and the third ASINR 506 and a second logical network link 514 between the second ASINR 504 and the third ASINR 506.

In this example network 500, each ASINR 502, 504, 506 includes one or more network interfaces, routing functionality, and wireguard tunneling functionality. Accordingly, the build process for the three ASINRs 502, 504, 506 includes common layers for the network interfaces, routing, and wireguard tunneling. ASINRs 502 and 506 also include wstunnel tunneling functionality, whereas ASINR 504 does not include wstunnel functionality. Thus, the build process for ASINRs 502 and 506 includes an optional layer to add wstunnel functionality, and the build process for ASINR 504 does not include the optional layer for wstunnel functionality. Network 500 is merely an example. In other embodiments, other numbers and types of ASINRs 100 can be included in the network.

A system implementing ASINRs 100 can implement other security features to reduce the vulnerability of an ASINR 100. For example, because an ASINR 100 is relatively easy to replace, the system can be configured to automatically disable and/or replace an ASINR 100. The automatic disabling and/or replacement can be time based. For example, the system can replace one or more of the ASINRs 100 periodically (e.g., once a month). Such a periodic replacement scheme can update each ASINR 100 with the current version of the functionality images (e.g., the current WireGuard image) which reduces vulnerabilities. Additionally, any access that an attacker had gained to an ASINR 100 will be removed by disabling and replacing the ASINR 100.

In another example, an ASINR 100 can be deployed for temporary service and disabled afterwards. For example, if access is to be granted to a network for an individual for 1 week, the system (in response to input from an administrator) can build an ASINR 100 solely to provide access to the network for the individual including related functionality. The system can then automatically disable the ASINR 100 at 1 week, such that the individual's access is automatically removed. This reduces vulnerability as compared to existing systems that are reliant on manual configuration to provide and remove access to the network. Oftentimes, once an individual is granted access, that access is not promptly removed and the lingering access point provides a vulnerability that an attacker can exploit.

In another example, the system can activate and disable an ASINR 100 based on a time, such as a time of day, day of the week, month, etc. For example, the system 100 can activate and disable an ASINR 100 such that it is active from 8 am to 5 pm US Central Standard time during weekdays (Monday-Friday) and is disabled during all other periods. The ASINR 100 can be configured to grant access for one or more individuals to one or more services. By activating and disabling the ASINR 100 in this way, access to the services can be provided during desired time periods and disabled for other time periods, thereby reducing the time periods during which the ASINR 100 can be exploited by an attacker.

In still other examples, the system can activate/disable an ASINR 100 based on its location (e.g., the location of the device that is executing the ASINR 100) or the identity of the device that is executing the ASINR 100. Such a scheme can be used to ensure the ASINR 100 only executes in the desired location and/or by the desired device.

In yet other examples, the system can automatically disable and/or replace an ASINR 100 based on the amount of data that the ASINR 100 passes. For example, the system will disable the ASINR 100 once it passes 1 Terabyte of data.

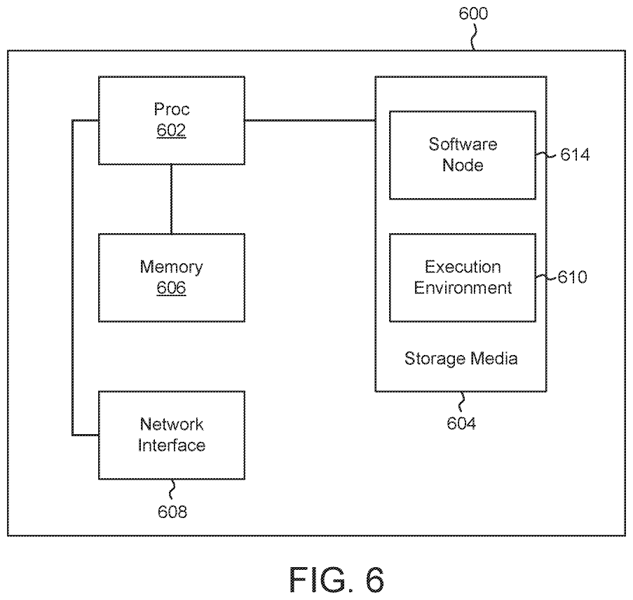

FIG. 6 is a block diagram of an example device 600 which can host an execution environment for an ASINR 100. The host device 600 is a physical computing device having one or more processing devices 602 for executing computer readable instructions. The one or more processing devices 602 can include a general-purpose processor or a special purpose processor. The instructions can be stored (or otherwise embodied) on or in an appropriate storage medium 604 or media (such as a hard drive or other non-volatile storage) from which the instructions are readable by the processing device(s) for execution thereby. The one or more processing devices 602 can be coupled to the storage medium 604 or media to access the instructions therefrom. As described in more detail herein, the instructions can include execution environment instructions 6 10 which, when executed by the processing device(s) 602, cause the host device 600 to perform the functions of an execution environment as described herein. In an example, the execution environment instructions can execute an operating system, a hypervisor, or a Docker Engine as described herein.

The instructions can also include ASINR instructions 614 which, when executed by the processing device(s) 602, cause the host device 600 to perform the functions of an ASINR 100 as described herein.

The host device 600 also includes memory 606 that is coupled to the processing device(s) 602 for storing instructions and related data during execution by the processing device(s) 602. Memory 606 can comprise any suitable form of random-access memory (RAM) now known or later developed, such as dynamic random-access memory (DRAM). Other types of memory can be used. The host device 600 includes at least one network interface 608, such as an Ethernet interface. In an example, the host device 600 can include a human machine interface (HMI) for interacting with a human.

1-7. (canceled)

8. One or more non-transitory computer-readable mediums including:
code that implements an internetworking device including:
code that implements a plurality of network ports, each of the plurality of network ports including a physical layer protocol and a data link layer protocol for each of the plurality of network ports, wherein the plurality of network ports are not configurable by an external operator;
code that implements one or more routing protocols for transferring packets between the plurality of network ports, wherein the one or more routing protocols are not configurable by an external operator;
code that implements one or more IP addresses associated with each of the plurality of ports, wherein the one or more IP addresses are not configurable by an external operator; and
code that implements one or more network layer protocols for each of the plurality of network ports, wherein the one or more network layer protocols are not configurable by an external operator.

9. The one or more non-transitory computer-readable mediums of claim 8, wherein the code that implements an internetworking device includes:
code that implements access controls indicating which packets are allowed to be transferred to which ports, wherein the access controls are not configurable by an external operator.

10. The one or more non-transitory computer-readable mediums of claim 8, wherein code that implements the internetworking device is a Docker image.

11. The one or more non-transitory computer-readable mediums of claim 8, wherein the physical layer protocol and the data link layer protocol for each of the plurality of network ports are one of the IEEE 802.3 protocols.

12. The one or more non-transitory computer-readable mediums of claim 8, wherein the one or more routing protocols include one of a BGP protocol or an OSPF protocol.

13. The one or more non-transitory computer-readable mediums of claim 8, wherein the one or more network layer protocols includes one or more of an IPsec protocol, a protocol provided by WireGuard, a websocket, or an SSL protocol.

14. The one or more non-transitory computer-readable mediums of claim 8, wherein the internetworking device does not include an interface for an external operator to log-in to the internetworking device.

15-20. (canceled)

21. A method for building an application specific network router, the method comprising:
providing a plurality of functions and corresponding attributes to be implemented by the application specific network router;
providing a first container image corresponding to a network router;
adding one or more layers to the first container image to incorporate the plurality of functions and corresponding attributes and form a second container image that is configured to implement the application specific network router, wherein the second container image does not provide any programming interface for modifying the plurality of functions or corresponding attributes; and
running the second container image on an appropriate container runtime engine.

22. The method of claim 21, wherein the plurality of functions and corresponding attributes includes network address and port functionality, virtual tunneling functionality, access control functionality, and network service functionality.

23. The method of claim 21, comprising:
receiving information from a user indicating the plurality of functions and corresponding attributes to be implemented by the application specific network router.

24. The method of claim 21, wherein the plurality of functions and corresponding attributes is configured to implement one or more virtual private network (VPN) tunnels.

25. The method of claim 21, wherein the second container image is configured such that the plurality of functions and corresponding attributes are immutable.

26. The method of claim 21, wherein the second container image is configured to execute within a Docker engine on one of a virtual machine, a virtual operating system (OS), or a bare metal server.

27. The method of claim 21, wherein the second container image is configured to implement functionality including:
at least one virtual private network (VPN) tunnel between the application specific network router and another second application specific network router;
user-based access restrictions for network services; and
one or more routing tables for routing packets.

28. One or more non-transitory computer-readable mediums including:
a container configured to implement an application specific network router that provides a plurality of functions and has a plurality of corresponding attributes, wherein the second container image does not provide any programming interface for modifying the plurality of functions or corresponding attributes, wherein the container is configured to run on an appropriate container runtime engine.

29. The computer-readable mediums of claim 28, wherein the plurality of functions and corresponding attributes includes network address and port functionality, virtual tunneling functionality, access control functionality, and network service functionality.

30. The computer-readable mediums of claim 28, wherein the container is configured to implement functionality including:
at least one virtual private network (VPN) tunnel between the application specific network router and another second application specific network router;
user-based access restrictions for network services; and
one or more routing tables for routing packets

31. The computer-readable mediums of claim 28, wherein the plurality of functions and corresponding attributes are configured to implement one or more virtual private network (VPN) tunnels.

32. The computer-readable mediums of claim 28, wherein the second container image is configured such that the plurality of functions and the plurality of corresponding attributes are immutable.

33. The computer-readable mediums of claim 28, wherein the container is configured to execute within a Docker engine on one of a virtual machine, a virtual operating system (OS), or a bare metal server.
